(19) United States
(12) Patent Application Publication
(10) Pub. No.: US 2026/0001987 A1
(43) Pub. Date: Jan. 1, 2026

(54) POLYCARBONATE RESIN COMPOSITION AND MOLDED ARTICLE THEREOF

(71) Applicant: MITSUBISHI CHEMICAL CORPORATION, Tokyo (JP)

(72) Inventors: Hiroki ASABA, Tokyo (JP); Yukinori KOMIYA, Tokyo (JP); Masashi YOKOGI, Tokyo (JP)

(73) Assignee: MITSUBISHI CHEMICAL CORPORATION, Tokyo (JP)

(21) Appl. No.: 19/311,081

(22) Filed: Aug. 27, 2025

Related U.S. Application Data
(63) Continuation of application No. PCT/JP2024/013074, filed on Mar. 29, 2024.

(30) Foreign Application Priority Data
Mar. 30, 2023 (JP) 2023-054759

(51) Int. Cl. C08G 64/06

(52) U.S. Cl. CPC C08G 64/06

(57) ABSTRACT

A polycarbonate resin composition containing: a carbonate structural unit (X) derived from an aliphatic dihydroxy compound represented by at least one selected from the group consisting of Formula (1), Formula (2), and Formula (8); and a carbonate structural unit (Y) derived from an aromatic dihydroxy compound represented by Formula (3), wherein a content of the carbonate structural unit (X) is 10 mass % or more and less than 26 mass %, and a content of the carbonate structural unit (Y) is more than 74 mass % and 90 mass % or less, per 100 mass % of all carbonate structural units of the polycarbonate resin composition.

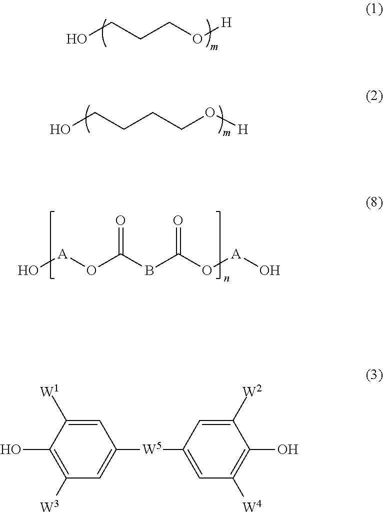

### CROSS-REFERENCE TO RELATED APPLICATIONS

The present application is a continuation of International Patent Application PCT/JP2024/013074, filed Mar. 29, 2024, which is based on and claims the benefit of priority to Japanese Patent Application No. 2023-054759 filed on Mar. 30, 2023. The entire contents of these applications are incorporated herein by reference.

### TECHNICAL FIELD

The present invention relates to a polycarbonate resin composition and a molded article, such as an injection molded article and an extrusion molded article, of the polycarbonate resin composition.

### BACKGROUND ART

Polycarbonate resins are excellent in mechanical strength, electrical properties, transparency, etc., and are utilized in various fields such as the electric/electronic equipment field and the automobile field.

However, polycarbonate resins are more easily scratched than glass, and have a disadvantage that their appearance is easily impaired when they are made into products. In order to overcome this disadvantage, polycarbonate resins having improved surface hardness and scratch resistance have been developed (Patent Documents 1, 2, and 3).

However, the polycarbonate resins of Patent Documents 1 to 3 are not completely scratch-free, and scratches gradually accumulate and their appearance is impaired over time during use.

As a means for solving this issue, it is conceivable to apply a hard coat to a polycarbonate resin to further improve its surface hardness. However, it is generally known that the hard coat treatment increases the number of steps for commercialization, and that the application of the hard coat adversely affects physical properties of the polycarbonate resin, for example, the polycarbonate resin becomes brittle.

In recent years, materials that do not make scratches less likely to be generated but allow the scratches to be naturally recovered, so-called self-healing polymers, have been reported. The self-healing polymers are aesthetically pleasing for a long time because scratches, even when made, fade over time.

However, no self-healing polycarbonate has been proposed.

### CITATION LIST

### Patent Document

Patent Document 1: JP 2021-102739 A
Patent Document 2: JP 2021-88651 A
Patent Document 3: JP 5802495B

### SUMMARY OF INVENTION

### Technical Problem

An object of the present invention is to provide a polycarbonate resin composition which is excellent in heat resistance and mechanical strength originally required of a polycarbonate resin and has self-healing properties, and to provide a molded article thereof.

### Solution to Problem

The present inventors have found that a polycarbonate resin composition containing a carbonate structural unit derived from a specific aliphatic dihydroxy compound and a carbonate structural unit derived from a specific aromatic dihydroxy compound in a specific ratio can maintain excellent physical properties of a polycarbonate resin such as heat resistance and mechanical strength while having a property that scratches disappear by heat.

The gist of the present invention is in the following [1] to [14].

[1] A polycarbonate resin composition containing:
a carbonate structural unit (X) derived from an aliphatic dihydroxy compound represented by at least one selected from the group consisting of Formula (1), Formula (2), and Formula (8); and
a carbonate structural unit (Y) derived from an aromatic dihydroxy compound represented by Formula (3),
wherein
a content of the carbonate structural unit (X) is 10 mass % or more and less than 26 mass %, and a content of the carbonate structural unit (Y) is more than 74 mass % and 90 mass % or less, per 100 mass % of all carbonate structural units of the polycarbonate resin composition.

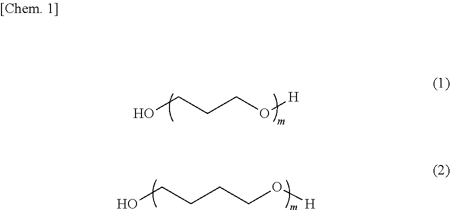

In Formulae (1) and (2), m is an integer of 2 or more.

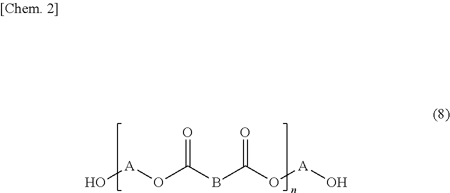

In Formula (8),
A represents a divalent linking group having no cyclic structure, the divalent linking group consisting of from 1 to 15 carbon atoms, from 0 to 1 oxygen atom, and a hydrogen atom, and a plurality of A's in Formula (8) are the same.
B represents a divalent linking group having no cyclic structure, the divalent linking group consisting of from 1 to 40 carbon atoms and a hydrogen atom.
n is an integer from 2 to 100.

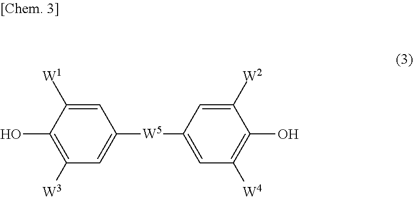

In Formula (3), W¹ to W⁴ are each independently a hydrogen atom, an alkyl group having from 1 to 10 carbon atoms, or an aryl group having from 6 to 12 carbon atoms.

W⁵ is —CR¹R²— (R¹ and R² are each independently a hydrogen atom, an alkyl group having from 1 to 10 carbon atoms, or an aryl group having from 6 to 12 carbon atoms) or a cycloalkylidene group having from 3 to 10 carbon atoms.

[2] The polycarbonate resin composition according to [1], wherein the polycarbonate resin composition contains a copolymerized polycarbonate resin containing the carbonate structural unit (X) and the carbonate structural unit (Y).

[3] The polycarbonate resin composition according to [1] or [2], wherein the polycarbonate resin composition is a mixture of a polycarbonate resin containing the carbonate structural unit (X) and a polycarbonate resin containing the carbonate structural unit (Y).

[4] The polycarbonate resin composition according to any one of [1] to [3], wherein the content of the carbonate structural unit (X) per 100 mass % of all the carbonate structural units of the polycarbonate resin composition is less than 20 mass %.

[5] The polycarbonate resin composition according to any one of [1] to [4], wherein the aromatic dihydroxy compound represented by Formula (3) is an aromatic dihydroxy compound represented by Formula (4) and/or Formula (5).

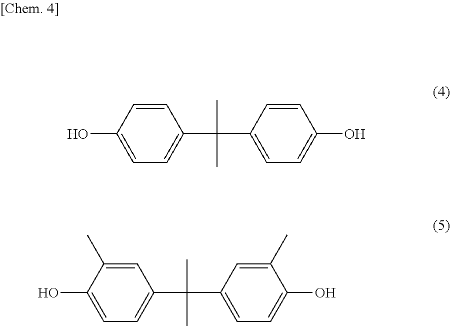 [SMILES: CC(C)(c1ccc(O)cc1)c1ccc(O)cc1 ; Cc1cc(C(C)(C)c2ccc(O)c(C)c2)ccc1O]

[6] The polycarbonate resin composition according to any one of [1] to [5], wherein the aliphatic dihydroxy compound represented by Formula (8) is an aliphatic polyester polyol represented by Formula (9).

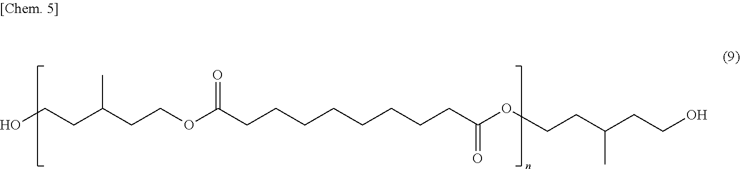

In Formula (9), n is an integer of from 2 to 100.

[7] The polycarbonate resin composition according to any one of [1] to [6], wherein the polycarbonate resin composition has a glass transition temperature of 110° C. or lower.

[8] The polycarbonate resin composition according to any one of [1] to [7], wherein the aliphatic dihydroxy compound represented by at least one selected from the group consisting of Formula (1), Formula (2), and Formula (8) has a number average molecular weight of 20000 or less.

[9] The polycarbonate resin composition according to any one of [1] to [8], wherein the polycarbonate resin composition has a tensile modulus of elasticity of 100 MPa or more and 3000 MPa or less.

[10] The polycarbonate resin composition according to any one of [1] to [9], wherein the polycarbonate resin composition has a viscosity average molecular weight (Mv) in a range from 13000 to 32000.

[11] A molded article containing the polycarbonate resin composition described in any one of [1] to [10].

[12] An injection molded article containing the polycarbonate resin composition described in any one of [1] to [10].

[13] An extrusion molded article containing the polycarbonate resin composition described in any one of [1] to [10].

### Advantageous Effects of Invention

According to the present invention, a polycarbonate resin composition having excellent self-healing properties, heat resistance, and mechanical strength, and a molded article thereof can be provided. The polycarbonate resin composition of the present invention has good self-healing properties, heat resistance, and mechanical strength, and therefore can be widely used in the industrial field such as interior parts of automobiles.

### DESCRIPTION OF EMBODIMENTS

Hereinafter, the present invention will be described in detail with reference to embodiments, examples, and the like. However, the present invention is not limited to the embodiments, examples, and the like described below.

In the present specification, numerical values described before and after the term “to” are respectively the lower limit and the upper limit of a range including the numerical values, unless otherwise specified.

### Polycarbonate Resin Composition

The polycarbonate resin composition of the present invention is a polycarbonate resin composition containing: a carbonate structural unit (X) (hereinafter sometimes simply referred to as “carbonate structural unit (X)”) derived from an aliphatic dihydroxy compound represented by at least one selected from the group consisting of Formula (1), Formula (2), and Formula (8) (hereinafter sometimes simply referred to as “specific aliphatic dihydroxy compound of the present invention”); and a carbonate structural unit (Y) (hereinafter sometimes simply referred to as “carbonate structural unit (Y)”) derived from an aromatic dihydroxy compound represented by Formula (3) (hereinafter sometimes simply referred to as “aromatic dihydroxy compound (3)”), wherein a content of the carbonate structural unit (X) is 10 mass % or more and less than 26 mass %, and a content of the carbonate structural unit (Y) is more than 74 mass % and 90 mass % or less, per 100 mass % of all carbonate structural units of the polycarbonate resin composition:

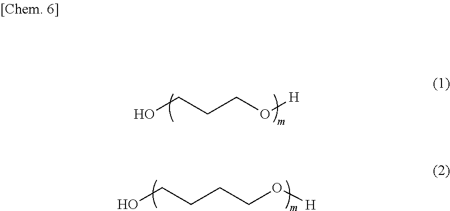

In Formulae (1) and (2), m is an integer of 2 or more.

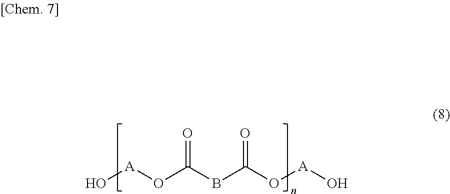

In Formula (8), A represents a divalent linking group having no cyclic structure, the divalent linking group consisting of from 1 to 15 carbon atoms, from 0 to 1 oxygen atom, and a hydrogen atom, and a plurality of A's in Formula (8) are the same.

B represents a divalent linking group having no cyclic structure, the divalent linking group consisting of from 1 to 40 carbon atoms and a hydrogen atom.

n is an integer from 2 to 100.

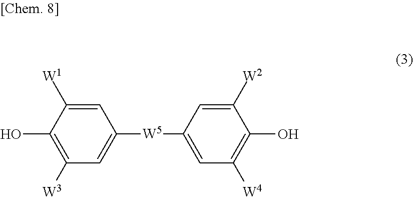

In Formula (3), W¹ to W⁴ are each independently a hydrogen atom, an alkyl group having from 1 to 10 carbon atoms, or an aryl group having from 6 to 12 carbon atoms.

W⁵ is —CR¹R²— (R¹ and R² are each independently a hydrogen atom, an alkyl group having from 1 to 10 carbon atoms, or an aryl group having from 6 to 12 carbon atoms) or a cycloalkylidene group having from 3 to 10 carbon atoms.

Hereinafter, the contents of the carbonate structural unit (X), the carbonate structural unit (Y), and an additional carbonate structural unit are all expressed in weight percentage relative to 100 mass % of all carbonate structural units in the polycarbonate resin composition.

By adopting the configuration of the polycarbonate resin composition of the present invention, the carbonate structural unit (X) derived from the specific aliphatic dihydroxy compound of the present invention forms a soft segment, and the carbonate structural unit (Y) derived from the aromatic dihydroxy compound (3) represented by Formula (3) forms a hard segment, whereby self-healing properties capable of maintaining the shape while the generated scratch disappears by applying heat can be exhibited.

That is, excellent self-healing properties are obtained by the soft segment formed by the carbonate structural unit (X). In addition, the polycarbonate resin is excellent also in heat resistance and mechanical strength due to the hard segment formed by the carbonate structural unit (Y). Therefore, a polycarbonate resin composition and a molded article having heat resistance and mechanical strength and also having self-healing properties can be obtained.

### Carbonate Structural Unit (X)

The carbonate structural unit (X) contained in the polycarbonate resin composition of the present invention is a carbonate structural unit derived from the specific aliphatic dihydroxy compound of the present invention.

A in Formula (8) is preferably a linear or branched alkylene group having from 1 to 6 carbon atoms from the viewpoint of polymerizability. The branched chain is preferably a branched alkylene group having from 1 to 6 carbon atoms and having a methyl group.

B in Formula (8) is preferably a linear alkylene group having from 1 to 10 carbon atoms.

The aliphatic polyester polyol represented by Formula (8) is preferably an aliphatic polyester polyol represented by Formula (9) from the viewpoint of availability and polymerizability.

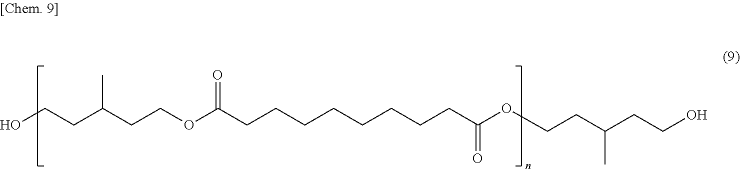

n is an integer of from 2 to 100.

As the aliphatic polyester polyol represented by Formula (9), it is preferable to use a biomass-derived aliphatic polyester polyol synthesized by condensing 3-methyl-1,5-pentanediol and sebacic acid produced from a plant-derived raw material.

Whether or not the aliphatic polyester polyol is produced from plant-derived resources can be confirmed by, for example, measuring the concentration of radioactive carbon (¹⁴C).

The specific aliphatic dihydroxy compound of the present invention desirably has a number average molecular weight of 20000 or less. An upper limit of the number average molecular weight of the specific aliphatic dihydroxy compound of the present invention is more preferably 10000 or less, and particularly preferably 5000 or less. When the number average molecular weight of the specific aliphatic dihydroxy compound of the present invention is not higher than the above upper limit, the compatibility with the aromatic dihydroxy compound (3) is good, and polymerization failure due to poor compatibility can be prevented.

On the other hand, a lower limit of the number average molecular weight of the specific aliphatic dihydroxy compound of the present invention is not particularly limited, but is usually 200 or more, and preferably 400 or more from the viewpoint of achieving both self-healing properties and heat resistance.

Therefore, m in Formulae (1) and (2) and n in Formula (8) are preferably numbers satisfying the preferred range of the number average molecular weight.

The number average molecular weight of the specific aliphatic dihydroxy compound of the present invention can be calculated by a measurement method by ¹H-NMR.

### Carbonate Structural Unit (Y)

The carbonate structural unit (Y) contained in the polycarbonate resin composition of the present invention is a carbonate structural unit derived from the aromatic dihydroxy compound (3).

In Formula (3), W¹ to W⁴ are each independently a hydrogen atom, an alkyl group having from 1 to 10 carbon atoms, or an aryl group having from 6 to 12 carbon atoms.

In the present invention, the number of carbon atoms of the group such as an alkyl group is, when the alkyl group contains a substituent, the number of carbon atoms of the entire group including the carbon atoms of the substituent.

Also with respect to the aryl group having from 6 to 12 carbon atoms, when the aryl group contains a substituent, the number of carbon atoms thereof is a total of the number of carbon atoms of the substituent and the number of carbon atoms of the aryl group.

The alkyl groups having from 1 to 10 carbon atoms represented by W¹ to W⁴ may be unsubstituted or may contain a substituent. The alkyl groups may be linear, branched, or cyclic.

Examples of the substituent which may be contained in the alkyl groups include a halogen atom, a nitro group, a cyano group, a hydroxy group, an aryl group, an alkoxy group, an aryloxy group, a carboxyl group, an alkoxycarbonyl group, an acyl group, and an acyloxy group.

Specific examples of the alkyl group having from 1 to 10 carbon atoms as W¹ to W⁴ in Formula (3) include:
a methyl group, an ethyl group, an n-propyl group, an n-butyl group, an n-pentyl group, an n-hexyl group, an n-heptyl group, an n-octyl group, an n-nonyl group, and an n-decyl group;
a methylethyl group, a methylpropyl group, a methylbutyl group, a methylpentyl group, a methylhexyl group, a methylheptyl group, a methyloctyl group, and a methylnonyl group;
a dimethylethyl group, a dimethylpropyl group, a dimethylbutyl group, a dimethylpentyl group, a dimethylhexyl group, a dimethylheptyl group, and a dimethyloctyl group;
a trimethylpropyl group, a trimethylbutyl group, a trimethylpentyl group, a trimethylhexyl group, and a trimethylheptyl group;
an ethylbutyl group, an ethylpentyl group, an ethylhexyl group, an ethylheptyl group, and an ethyloctyl group; and
a cyclohexyl group, a methylcyclohexyl group, a dimethylcyclohexyl group, a trimethylcyclohexyl group, a tetramethylcyclohexyl group, an ethylcyclohexyl group, a diethylcyclohexyl group, and a methylethylcyclohexyl group.

The aryl groups having from 6 to 12 carbon atoms represented by W¹ to W⁴ may be unsubstituted or may contain a substituent.

Examples of the substituent which may be contained in the aryl groups include a halogen atom, a nitro group, a cyano group, a hydroxy group, an alkyl group, an alkoxy group, an aryloxy group, a carboxy group, an alkoxycarbonyl group, an acyl group, and an acyloxy group.

Specific examples of the aryl groups having from 6 to 12 carbon atoms as W¹ to W⁴ in Formula (3) include a phenyl group, a tolyl group, and a naphthyl group.

In Formula (3), W⁵ is —CR¹R²— (R¹ and R² are each independently a hydrogen atom, an alkyl group having from 1 to 10 carbon atoms, or an aryl group having from 6 to 12 carbon atoms) or a cycloalkylidene group having from 3 to 10 carbon atoms.

The hydrogen atoms, the alkyl groups having from 1 to 10 carbon atoms, or the aryl groups having from 6 to 12 carbon atoms as R¹ and R² in the “—CR¹R²—” represented by W⁵ are the same as those in W¹ to W⁴.

The cycloalkylidene group having from 3 to 10 carbon atoms represented by W⁵ may contain a branched structure, and may be unsubstituted or may contain a substituent.

The substituent which may be contained in the cycloalkylidene group is the same as the substituent which may be contained in the alkyl groups as W¹ to W⁴.

Specific examples of the cycloalkylidene group having from 3 to 10 carbon atoms represented by W⁵ include a cyclopentylidene group and a cyclohexylidene group.

Among these, it is preferable that W¹ to W⁴ be each independently a hydrogen atom or a methyl group, and that W⁵ be —CR¹R²— (R¹ and R² are each independently a hydrogen atom or a methyl group), and it is more preferable that W¹ to W⁴ be each independently a hydrogen atom or a methyl group, and that W⁵ be a 2,2-propylidene group (in a case where R¹ and R² in —CR¹R²— are methyl groups).

Specific examples of the aromatic dihydroxy compound represented by Formula (3) include 2,2-bis(4-hydroxyphenyl) propane (=bisphenol A) (hereinafter sometimes abbreviated as “BPA”) represented by Formula (4), and 2,2-bis(4-hydroxy-3-methylphenyl) propane (=bisphenol C) (hereinafter sometimes abbreviated as “BPC”) represented by Formula (5).

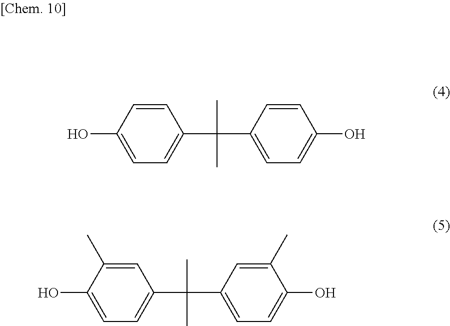 [SMILES: CC(C)(c1ccc(O)cc1)c1ccc(O)cc1 ; Cc1cc(C(C)(C)c2ccc(O)c(C)c2)ccc1O]

### Containing Form of Carbonate Structural Unit (X) and Carbonate Structural Unit (Y)

The polycarbonate resin composition of the present invention has only to contain the carbonate structural unit (X) and the carbonate structural unit (Y) so that content proportions of the carbonate structural unit (X) and the carbonate structural unit (Y) are as described above, and the containing forms of the carbonate structural unit (X) and the carbonate structural unit (Y) are not particularly limited.

Usually, the carbonate structural unit (X) and the carbonate structural unit (Y) are contained in polycarbonate resins.

The polycarbonate resin composition of the present invention may be a polycarbonate resin mixture (blend) of a polycarbonate resin containing the carbonate structural unit (X) and a polycarbonate resin containing the carbonate structural unit (Y), or may contain a copolymerization type polycarbonate resin simultaneously containing the carbonate structural unit (X) and the carbonate structural unit (Y).

The polycarbonate resin composition of the present invention may be a mixture of a polycarbonate resin containing the carbonate structural unit (X) or the carbonate structural unit (Y) and a copolymerized polycarbonate resin containing the carbonate structural unit (X) and the carbonate structural unit (Y), or may be a mixture of a polycarbonate resin containing the carbonate structural unit (X), a polycarbonate resin containing the carbonate structural unit (Y), and a copolymerized polycarbonate resin containing the carbonate structural unit (X) and the carbonate structural unit (Y). Furthermore, the polycarbonate resin composition of the present invention may contain a polycarbonate resin containing neither the carbonate structural unit (X) nor the carbonate structural unit (Y), in addition to a mixture of a polycarbonate resin containing the carbonate structural unit (X) and a polycarbonate resin containing the carbonate structural unit (Y), or a copolymerized polycarbonate resin containing the carbonate structural units (X) and (Y).

In the present invention, the “polycarbonate resin composition” includes both concepts of “a polycarbonate resin mixture containing a plurality of polycarbonate resins” and “a copolymerized polycarbonate resin”.

When the polycarbonate resin composition of the present invention contains the carbonate structural unit (X) and the carbonate structural unit (Y) as a copolymerized polycarbonate resin containing the carbonate structural unit (X) and the carbonate structural unit (Y), the polycarbonate resin composition of the present invention is referred to as “polycarbonate resin”.

When the polycarbonate resin composition of the present invention is a mixture of a polycarbonate resin containing the carbonate structural unit (X) and a polycarbonate resin containing the carbonate structural unit (Y), the polycarbonate resin composition is usually referred to as “polycarbonate resin composition”. The same applies to the other containing forms.

In the present invention, the term “polycarbonate resin composition” is used to include the case where the polycarbonate resin composition is composed of one type of copolymerized polycarbonate resin containing the carbonate structural unit (X) and the carbonate structural unit (Y).

In Examples 1 to 8 and Comparative Examples 1 to 3 described below, a single copolymerized polycarbonate resin is produced, and therefore, the resin is referred to as “polycarbonate resin” (“polycarbonate resin” of the present invention), but this is also included in the polycarbonate resin composition of the present invention.

### Content of Each of Carbonate Structural Unit (X) and Carbonate Structural Unit (Y)

When the polycarbonate resin composition of the present invention contains the carbonate structural unit (X) and the carbonate structural unit (Y), and contains the carbonate structural unit (X) in an amount of 10 mass % or more and less than 26 mass % and the carbonate structural unit (Y) in an amount of more than 74 mass % and 90 mass % or less, the polycarbonate resin composition of the present invention can have good self-healing properties, heat resistance, and mechanical strength.

The content of the carbonate structural unit (X) in the polycarbonate resin composition of the present invention is 10 mass % or more, preferably 13 mass % or more, and more preferably 16 mass % or more, from the viewpoint of self-healing properties. On the other hand, from the viewpoint of heat resistance and mechanical strength, the content of the carbonate structural unit (X) is less than 26 mass %, preferably less than 20 mass %, more preferably 19 mass % or less, and still more preferably 18.5 mass % or less.

The content of the carbonate structural unit (Y) in the polycarbonate resin composition of the present invention is more than 74 mass %, preferably 80 mass % or more, more preferably 81 mass % or more, and still more preferably 81.5 mass % or more, from the viewpoint of heat resistance and mechanical strength. On the other hand, from the viewpoint of self-healing properties, the content proportion of the carbonate structural unit (Y) is 90 mass % or less, preferably 87 mass % or less, and more preferably 84 mass % or less.

The polycarbonate resin composition of the present invention may contain only one type of the carbonate structural unit (X), or may contain two or more types thereof. That is, the polycarbonate resin composition may contain the carbonate structural unit (X) derived from two or more types of the specific aliphatic dihydroxy compounds of the present invention. Those of one type of molecular weight grade may be used, or those of two or more types of molecular weight grades may be used. The polycarbonate resin composition may also contain only one type of the carbonate structural unit (Y), or may contain two or more types thereof. That is, the polycarbonate resin composition may contain the carbonate structural unit (Y) derived from two or more types of the aromatic dihydroxy compounds (3).

As described above, the contents of the carbonate structural units (X) and (Y) are each expressed in weight percentage relative to 100 mass % of all the carbonate structural units in the polycarbonate resin composition.

Specifically, the contents of the carbonate structural units (X) and (Y) in the polycarbonate resin composition of the present invention can be determined as the proportions of the carbonate units derived from the respective dihydroxy compounds, that is, the carbonate unit derived from the specific aliphatic dihydroxy compound of the present invention and the carbonate unit derived from the aromatic dihydroxy compound (3), in all the carbonate units derived from all the dihydroxy compounds used in the production of the polycarbonate resin composition of the present invention.

The content of each of the carbonate structural units (X) and (Y) in the polycarbonate resin composition can be calculated by a measurement method by ¹H-NMR. The same applies to an additional carbonate structural unit described later.

When the carbonate structural unit (X) includes any one type selected from the group consisting of the carbonate structural unit derived from the aliphatic dihydroxy compound represented by Formula (1), the structural unit derived from the aliphatic dihydroxy compound represented by Formula (2), and the carbonate structural unit derived from the aliphatic dihydroxy compound represented by Formula (8), the content of the carbonate structural unit (X) is a proportion of the amount of the one type of structural unit to 100 mass % of all the carbonate structural units in the polycarbonate resin composition of the present invention. In addition, when the carbonate structural unit (X) includes two or more types selected from the group consisting of the carbonate structural unit derived from the aliphatic dihydroxy compound represented by Formula (1), the structural unit derived from the aliphatic dihydroxy compound represented by Formula (2), and the carbonate structural unit derived from the aliphatic dihydroxy compound represented by Formula (8), the content of the carbonate structural unit (X) is a proportion of a total amount of these two types of structural units to 100 mass % of all the carbonate structural units in the polycarbonate resin composition of the present invention. The same applies to the case where the polycarbonate resin composition of the present invention contains all of the carbonate structural unit derived from the aliphatic dihydroxy compound represented by Formula (1), the carbonate structural unit derived from the aliphatic dihydroxy compound represented by Formula (2), and the carbonate structural unit derived from the aliphatic dihydroxy compound represented by Formula (8). Similarly, when the polycarbonate resin composition contains two or more types of the carbonate structural units derived from the aliphatic dihydroxy compound represented by Formula (1), two or more types of the carbonate structural units derived from the aliphatic dihydroxy compound represented by Formula (2), or two or more types of the carbonate structural units derived from the aliphatic dihydroxy compound represented by Formula (8), a proportion of a total amount of these structural units is the content of the carbonate structural unit (X).

The same applies to the carbonate structural unit (Y).

### Additional Carbonate Structural Unit

The polycarbonate resin composition of the present invention may contain additional carbonate structural units other than the carbonate structural unit (X) and the carbonate structural unit (Y), that is, carbonate structural units derived from aromatic and/or aliphatic dihydroxy compounds (hereinafter, sometimes referred to as “additional dihydroxy compounds”) other than the specific aliphatic dihydroxy compound of the present invention and the aromatic dihydroxy compound (3), within a range where the object of the present invention is not imparted.

The additional carbonate structural unit may also be contained as a copolymerized polycarbonate resin with the carbonate structural unit (X) and/or the carbonate structural unit (Y), or a polycarbonate resin composed of the additional carbonate structural unit may be mixed with a polycarbonate resin containing the carbonate structural unit (X) and/or the carbonate structural unit (Y).

When the polycarbonate resin composition of the present invention contains an additional carbonate structural unit, a content of the additional carbonate structural unit per 100 mass % of all the carbonate structural units of the polycarbonate resin composition is preferably 10 mass % or less, particularly preferably 5 mass % or less, and especially preferably 2 mass % or less.

When the polycarbonate resin composition contains an additional carbonate structural unit, an improvement effect such as a decrease in water absorption rate may be obtained due to the additional carbonate structural unit, but when the content thereof is too high, the effects of the present invention, that is, the improvements in self-healing properties, heat resistance, and mechanical strength due to the presence of the carbonate structural unit (X) and the carbonate structural unit (Y) may be impaired.

The polycarbonate resin composition of the present invention may contain only one type of the additional carbonate structural unit, or may contain two or more types of the additional carbonate structural units.

### Additional Component

The polycarbonate resin composition of the present invention may contain an additional component in addition to the polycarbonate resin containing the carbonate structural unit (X) and/or the carbonate structural unit (Y), as necessary, as long as the desired physical properties are not significantly impaired. Examples of the additional component include a polycarbonate resin containing neither the carbonate structural unit (X) nor the carbonate structural unit (Y), a resin other than the polycarbonate resin, and various resin additives.

Examples of an additional resin that can be contained in the polycarbonate resin composition of the present invention include thermoplastic polyester resins such as polyethylene terephthalate resin, polytrimethylene terephthalate, and polybutylene terephthalate resin; styrene-based resins such as polystyrene resin, high-impact polystyrene resin (HIPS), acrylonitrile-styrene copolymer (AS resin), acrylonitrile-styrene-acrylic rubber copolymer (ASA resin), and acrylonitrile-ethylene propylene-based rubber-styrene copolymer (AES resin); polyolefin resins such as polyethylene resin and polypropylene resin; polyamide resin; polyimide resin; polyetherimide resin; polyurethane resin; polyphenylene ether resin; polyphenylene sulfide resin; polysulfone resin; and polymethacrylate resin.

Only one type of the additional resin may be contained, or two or more types of the additional resins may be contained in any combination and ratio.

Examples of the resin additive include a heat stabilizer, an antioxidant, a mold release agent, a light stabilizer (HALS), a flame retardant, an antistatic agent, an antifogging agent, a lubricant, an antiblocking agent, a fluidity improver, a plasticizer, a dispersant, an antibacterial agent, a dye, and a pigment.

Among these resin additives, only one type may be contained, or two or more types may be contained in any combination and ratio.

### Tensile Modulus of Elasticity of Polycarbonate Resin Composition

The tensile modulus of elasticity of the polycarbonate resin composition of the present invention is not particularly limited, but is preferably 100 MPa or more and 3000 MPa or less, and particularly preferably 500 MPa or more and 2500 MPa or less, from the viewpoint of mechanical strength.

The tensile modulus of elasticity of the polycarbonate resin composition of the present invention is measured by the method described in the section of Examples below, for a test sample produced by obtaining a square pressed piece having a thickness of 0.5 mm and both vertical and horizontal lengths of 70 mm by hot pressing, and then cutting the square pressed piece into a thickness of 0.5 mm, a vertical length of 70 mm, and a horizontal length of 10 mm with scissors.

### Viscosity Average Molecular Weight of Polycarbonate Resin Composition

The viscosity average molecular weight of the polycarbonate resin composition of the present invention is not particularly limited, but is preferably 13000 or more and 32000 or less, and particularly preferably 17000 or more and 30000 or less, from the viewpoint of mechanical strength.

The viscosity average molecular weight of the polycarbonate resin composition of the present invention is measured by the method described in the section of Examples below.

### Glass Transition Temperature of Polycarbonate Resin Composition

The glass transition temperature of the polycarbonate resin composition of the present invention is not particularly limited, but is preferably −10° C. or higher and 120° C. or lower, more preferably 0° C. or higher and 110° C. or lower, and still more preferably 10° C. or higher and 100° C. or lower.

The glass transition temperature of the polycarbonate resin composition of the present invention is measured by the method described in the section of Examples below.

### Method for Producing Polycarbonate Resin Composition

### Method for Producing Polycarbonate Resin

The polycarbonate resin constituting the polycarbonate resin composition of the present invention can be produced by a known polymerization method, and the polymerization method is not particularly limited. Examples of the polymerization method include an interfacial polymerization method, a melt transesterification method, a pyridine method, a ring-opening polymerization method of a cyclic carbonate compound, and a solid phase transesterification method of a prepolymer. Among these, the melt transesterification method and the interfacial polymerization method are preferable. Hereinafter, particularly preferred methods among these methods will be described in detail.

### Interfacial Polymerization Method

In the interfacial polymerization method, a raw material dihydroxy compound and a carbonate-forming compound are reacted in the presence of an organic solvent inert to the reaction and an aqueous alkali solution, usually at a pH of 9 or more, and then interfacial polymerization is performed in the presence of a polymerization catalyst to produce a polycarbonate resin. In the reaction system, a molecular weight modifier (terminal stopper) may be present as necessary, and an antioxidant may be present for preventing oxidation of the raw material dihydroxy compound.

The organic solvent inert to the reaction is not particularly limited, and examples thereof include chlorinated hydrocarbons such as dichloromethane, 1,2-dichloroethane, chloroform, monochlorobenzene, and dichlorobenzene; and aromatic hydrocarbons such as benzene, toluene, and xylene. Only one type of the organic solvent may be used, or two or more types of the organic solvents may be used in any combination and ratio.

The alkali compound contained in the aqueous alkali solution is not particularly limited, and examples thereof include: alkali metal compounds such as sodium hydroxide, potassium hydroxide, lithium hydroxide, and sodium hydrogen carbonate; and alkaline earth metal compounds. Among these, sodium hydroxide and/or potassium hydroxide are/is preferable. Only one type of the alkali compound may be used, or two or more types of the alkali compounds may be used in any combination and ratio.

The concentration of the alkali compound in the aqueous alkali solution is not limited, but the alkali compound is usually used at a concentration of from 5 to 10 mass % in order to control a pH of the aqueous alkali solution to from 10 to 12. For example, when phosgene is blown, in order to control the pH of the aqueous phase to from 10 to 12, preferably from 10 to 11, the alkali compound is used in an amount of usually 1.9 mol or more, preferably 2.0 mol or more, and usually 3.2 mol or less, preferably 2.5 mol or less, relative to 1 mol of the raw material dihydroxy compound.

By using a dihydroxy compound containing the specific aliphatic dihydroxy compound of the present invention and the aromatic dihydroxy compound (3) as the raw material dihydroxy compound, a copolymerized polycarbonate resin containing the carbonate structural unit (X) and the carbonate structural unit (Y) can be produced. By using the specific aliphatic dihydroxy compound of the present invention, a polycarbonate resin containing the carbonate structural unit (X) can be produced. By using the aromatic dihydroxy compound (3), a polycarbonate resin containing the carbonate structural unit (Y) can be produced. In the case of producing the polycarbonate resin containing the additional carbonate structural unit, one or two or more types of dihydroxy compounds other than the specific aliphatic dihydroxy compound and the aromatic dihydroxy compound (3) of the present invention may be used.

As the carbonate-forming compound, carbonyl halides are suitably used, and among them, phosgene is preferably used. The process using phosgene is particularly called a phosgene process.

The polymerization catalyst is not particularly limited, and examples thereof include aliphatic tertiary amines such as trimethylamine, triethylamine, tributylamine, tripropylamine, and trihexylamine; alicyclic tertiary amines such as N,N′-dimethylcyclohexylamine and N,N′-diethylcyclohexylamine; aromatic tertiary amines such as N,N′-dimethylaniline and N,N′-diethylaniline; quaternary ammonium salts such as trimethylbenzylammonium chloride, tetramethylammonium chloride, and triethylbenzylammonium chloride; pyridine; guanine; and salts of guanidine. Only one type of the polymerization catalyst may be used, or two or more types of the polymerization catalysts may be used in any combination and ratio.

The molecular weight modifier is not particularly limited, and examples thereof include phenols having a monovalent phenolic hydroxy group; aliphatic alcohols such as methanol and butanol; mercaptans; and phthalic imide. Among these, phenols are preferable.

Specific examples of the phenols include phenol, o-n-butylphenol, m-n-butylphenol, p-n-butylphenol, o-isobutylphenol, m-isobutylphenol, p-isobutylphenol, o-t-butylphenol, m-t-butylphenol, p-t-butylphenol, o-n-pentylphenol, m-n-pentylphenol, p-n-pentylphenol, o-n-hexylphenol, m-n-hexylphenol, p-n-hexylphenol, p-t-octylphenol, o-cyclohexylphenol, m-cyclohexylphenol, p-cyclohexylphenol, o-phenylphenol, m-phenylphenol, p-phenylphenol, o-n-nonylphenol, m-n-nonylphenol, p-n-nonylphenol, o-cumylphenol, m-cumylphenol, p-cumylphenol, o-naphthylphenol, m-naphthylphenol, p-naphthylphenol, 2,5-di-t-butylphenol, 2,4-di-t-butylphenol, 3,5-di-t-butylphenol, 2,5-dicumylphenol, 3,5-dicumylphenol, p-cresol, bromophenol, tribromophenol, monoalkylphenols having a linear or branched alkyl group having from 12 to 35 carbon atoms on average at the ortho position, the meta position or the para position, 9-(4-hydroxyphenyl)-9-(4-methoxyphenyl) fluorene, 9-(4-hydroxy-3-methylphenyl)-9-(4-methoxy-3-methylphenyl) fluorene, and 4-(1-adamantyl) phenol. Among these, p-t-butylphenol, p-phenylphenol and p-cumylphenol are preferably used. Only one type of the molecular weight modifier may be used, or two or more types of the molecular weight modifiers may be used in any combination and ratio.

The amount of the molecular weight modifier to be used is not particularly limited, and is, for example, usually 0.5 mol or more, preferably 1 mol or more, and is usually 50 mol or less, preferably 30 mol or less, relative to 100 mol of the raw material dihydroxy compound.

The antioxidant is not particularly limited, and examples thereof include a hindered phenol-based antioxidant. Specific examples of the hindered phenol-based antioxidant include pentaerythritol tetrakis[3-(3,5-di-tert-butyl-4-hydroxyphenyl) propionate], octadecyl-3-(3,5-di-tert-butyl-4-hydroxyphenyl) propionate, thiodiethylene bis[3-(3,5-di-tert-butyl-4-hydroxyphenyl) propionate], N,N′-hexane-1,6-diylbis[3-(3,5-di-tert-butyl-4-hydroxyphenyl) propionamide], 2,4-dimethyl-6-(1-methylpentadecyl) phenol, diethyl[[3,5-bis(1,1-dimethylethyl)-4-hydroxyphenyl]methyl]phosphate, 3,3′,3″,5,5′,5″-hexa-tert-butyl-a,a′,a″-(mesitylene-2,4,6-tolyl)tri-p-cresol, 4,6-bis(octylthiomethyl)-o-cresol, ethylene bis(oxyethylene)bis[3-(5-tert-butyl-4-hydroxy-m-tolyl) propionate], hexamethylene bis[3-(3,5-di-tert-butyl-4-hydroxyphenyl) propionate], 1,3,5-tris(3,5-di-tert-butyl-4-hydroxybenzyl)-1,3,5-triazine-2,4,6(1H,3H,5H)-trione, 2,6-di-tert-butyl-4-(4,6-bis(octylthio)-1,3,5-triazin-2-ylamino) phenol, and 2-[1-(2-hydroxy-3,5-di-tert-pentylphenyl)ethyl]-4,6-di-tert-pentylphenyl acrylate.

Among them, pentaerythritol tetrakis[3-(3,5-di-tert-butyl-4-hydroxyphenyl) propionate] and octadecyl-3-(3,5-di-tert-butyl-4-hydroxyphenyl) propionate are preferable. Examples of commercially available products of such phenol-based antioxidants include “IRGANOX (registered trademark) 1010” and “IRGANOX (registered trademark) 1076” available from BASF, and “ADEKA STAB (registered trademark) AO-50” and “ADEKA STAB (registered trademark) AO-60” available from ADEKA. Only one type of the antioxidant may be used, or two or more types of the antioxidants may be used in any combination and ratio.

The amount of the antioxidant to be used is not particularly limited, but for example, is usually 0.001 parts by mass or more, preferably 0.01 parts by mass or more, and more preferably 0.1 parts by mass or more, and is usually 1 part by mass or less, and preferably 0.5 parts by mass or less, relative to 100 parts by mass of the raw material dihydroxy compound. When the amount of the antioxidant to be used is less than the lower limit of the above range, the effect as an antioxidant may be insufficient. When the amount of the antioxidant to be used exceeds the upper limit of the above range, gas may be easily generated at injection molding.

In the reaction, the order of mixing the reaction substrate (reaction raw material), the reaction solvent (organic solvent), the catalyst, the additive, and the like is freely selected as long as the desired polycarbonate resin is produced, and an appropriate order may be set in an appropriate manner. For example, when phosgene is used as the carbonate-forming compound, the molecular weight modifier can be mixed at any timing between the reaction (phosgenation) of the raw material dihydroxy compound and phosgene and the start of the polymerization reaction.

The reaction temperature is not particularly limited, but is usually from 0 to 40° C. The reaction time is not particularly limited, but is usually several minutes (e.g., 10 minutes) to several hours (e.g., 6 hours).

### Melt Transesterification Method

In the melt transesterification method, for example, a transesterification reaction of a carbonate ester and a raw material dihydroxy compound is performed. The raw material dihydroxy compound is the same as in the interfacial polymerization method.

The carbonate ester may be, for example, a compound represented by Formula (6), and examples thereof include diaryl carbonates, dialkyl carbonates, and carbonate forms of dihydroxy compounds such as biscarbonate forms of dihydroxy compounds, monocarbonate forms of dihydroxy compounds, and cyclic carbonates.

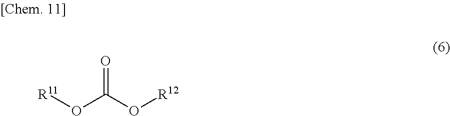

In Formula (6), R¹¹ and R¹² each independently represent an alkyl group or an aryl group. The alkyl groups and the aryl groups represented by R¹¹ and R¹² may be unsubstituted or may contain a substituent. The substituents which may be contained in the alkyl groups and the aryl groups are the same as the substituents which may be contained in the aryl groups as R¹³ and R¹⁴ in Formula (7) shown below. The number of carbon atoms of the alkyl groups represented by R¹¹ and R¹² is preferably from 1 to 30. The number of carbon atoms of the aryl groups represented by R¹¹ and R¹² is preferably from 6 to 30, and more preferably from 6 to 12.

Hereinafter, when R¹¹ and R¹² are alkyl groups, the carbonate is referred to as dialkyl carbonate, and when they are ary groups, the carbonate is referred to as diaryl carbonate.

Among these, from the viewpoint of reactivity with the dihydroxy compound, R¹¹ and R¹² are each independently preferably an aryl group which may contain a substituent. The carbonate ester is more preferably a diaryl carbonate represented by Formula (7), which may contain a substituent.

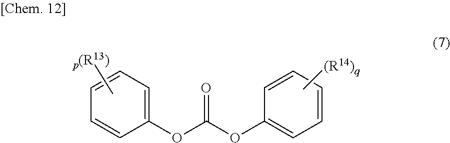

In Formula (7), R¹³ and R¹⁴ each independently represent a halogen atom, a nitro group, a cyano group, an alkyl group having from 1 to 20 carbon atoms, an aryl group having from 6 to 20 carbon atoms, a carboxylic acid group, an alkoxycarbonyl group having from 2 to 20 carbon atoms, or an acyloxy group having from 1 to 20 carbon atoms. p and q each independently represent an integer of from 0 to 5.

The alkoxycarbonyl group is a group represented by —C(═O)—OR²⁰ (R²⁰ is an alkyl group), and specific examples thereof include a methoxycarbonyl group and an ethoxycarbonyl group. The acyloxy group is a group represented by —O—C(═O)—R²¹ (R²¹ is a hydrogen atom, an alkyl group or an aryl group), and specific examples thereof include a formyloxy group and an acetyloxy group. p and q are each independently preferably an integer of from 0 to 3, and more preferably an integer of from 0 to 2.

Specific examples of the carbonate esters represented by Formula (6) and/or Formula (7) include dialkyl carbonates such as dimethyl carbonate, diethyl carbonate, and di-t-butyl carbonate, and diaryl carbonates such as diphenyl carbonate (hereinafter, sometimes abbreviated as “DPC”), bis(4-methylphenyl) carbonate, bis(4-chlorophenyl) carbonate, bis(4-fluorophenyl) carbonate, bis(2-chlorophenyl) carbonate, bis(2,4-difluorophenyl) carbonate, bis(4-nitrophenyl) carbonate, bis(2-nitrophenyl) carbonate, bis(methylsalicylphenyl) carbonate, and ditolyl carbonate. Among these, diphenyl carbonate is preferable. Among these carbonate esters, only one type may be used, or two or more types may be used in any combination and ratio.

The carbonate ester may be substituted with a dicarboxylic acid or dicarboxylic ester in an amount of preferably 50 mol % or less, more preferably 30 mol % or less. Typical examples of the dicarboxylic acid or dicarboxylic ester include terephthalic acid, isophthalic acid, diphenyl terephthalate, and diphenyl isophthalate. When substituted with such a dicarboxylic acid or dicarboxylic ester, polyester carbonates are produced.

The ratio of the carbonate ester to the raw material dihydroxy compound is freely selected as long as the desired polycarbonate resin is produced, but it is preferable to use the carbonate ester in excess relative to the raw material dihydroxy compound in polymerizing the carbonate ester with the dihydroxy compound.

The amount of the carbonate ester to be used is preferably from 1.01 to 1.30 mol, and more preferably from 1.01 to 1.20 mol, relative to 1 mol of the dihydroxy compound. If this molar ratio is too small, the terminal OH groups of the resulting polycarbonate resin increase, and the thermal stability of the resin tends to deteriorate. On the other hand, if this molar ratio is too large, the reaction rate of the transesterification may decrease, making it difficult to produce a polycarbonate resin having a desired molecular weight, or the amount of the carbonate ester remaining in the resin may increase, causing odor during molding or when a molded article is formed.

When a polycarbonate resin is produced by the melt transesterification method, a transesterification catalyst is usually used. The transesterification catalyst is not particularly limited, and a known catalyst can be used. For example, an alkali metal compound and/or an alkaline earth metal compound is preferably used. As an auxiliary, basic compounds such as a basic boron compound, a basic phosphorus compound, a basic ammonium compound, and an amine-based compound may be used in combination. Only one type of the transesterification catalyst may be used, or two or more types of the transesterification catalysts may be used in any combination and ratio.

In the melt transesterification method, the reaction temperature is not particularly limited, but is usually from 100 to 300° C. The pressure during the reaction is not particularly limited, but is usually a reduced pressure condition of 2 Torr or less. As a specific operation, the melt polycondensation reaction may be performed under the above-described conditions while removing by-products.

The polycarbonate resin composition of the present invention is significantly affected by thermal history and oxidation in the presence of an alkali catalyst, leading to deterioration of hue. Therefore, the reaction temperature is preferably 300° C. or lower. In order to prevent oxygen leakage from the equipment due to excessive pressure reduction, it is preferable to select pressure reduction conditions with a lower limit of about 0.05 Torr.

The reaction can be carried out by either a batch method or a continuous method. In the case of the batch method, the order of mixing the reaction substrate (reaction raw material), the catalyst, the additive, and the like is freely selected as long as the desired polycarbonate resin is produced, and an appropriate order may be set in an appropriate manner.

In the melt transesterification method, a catalyst deactivator may be used as necessary. As the catalyst deactivator, a compound that neutralizes the transesterification catalyst can be used. Examples of the catalyst deactivator include sulfur-containing acidic compounds and derivatives thereof, and phosphorus-containing acidic compounds and derivatives thereof. Only one type of the catalyst deactivator may be used, or two or more types of the catalyst deactivators may be used in any combination and ratio.

The amount of the catalyst deactivator to be used is not particularly limited, but is usually 0.5 equivalents or more, preferably 1 equivalent or more, and more preferably 3 equivalents or more, and is usually 50 equivalents or less, preferably 10 equivalents or less, and more preferably 8 equivalents or less, relative to the transesterification catalyst.

The amount of the catalyst deactivator to be used is usually 1 ppm or more and 100 ppm or less, preferably 50 ppm or less, relative to the polycarbonate resin.

### Method for Producing Polycarbonate Resin Composition

In a case where the polycarbonate resin composition of the present invention is a mixture of a polycarbonate resin containing the carbonate structural unit (X) and a polycarbonate resin containing the carbonate structural unit (Y), a case where the polycarbonate resin composition of the present invention is a mixture of a polycarbonate resin containing the carbonate structural unit (X) and/or the carbonate structural unit (Y) and a copolymerized polycarbonate resin containing the carbonate structural unit (X) and the carbonate structural unit (Y), or a case where the polycarbonate resin composition of the present invention is a polycarbonate resin composition containing two or more types of polycarbonate resins such as a mixture containing a polycarbonate resin containing neither the carbonate structural unit (X) nor the carbonate structural unit (Y), a method for producing the polycarbonate resin composition of the present invention by mixing a plurality of polycarbonate resins, for example, two types of polycarbonate resins, i.e., a polycarbonate resin (a) and a polycarbonate resin (b) is not particularly limited, but the following methods 1) to 4) and the like are exemplified:
1) a method of melt-kneading the polycarbonate resin (a) and the polycarbonate resin (b);
2) a method of melt-kneading the polycarbonate resin (a) in a molten state and the polycarbonate resin (b) in a molten state;
3) a method of mixing the polycarbonate resin (a) and the polycarbonate resin (b) in a solution state; and
4) a method of dry-blending the polycarbonate resin (a) and the polycarbonate resin (b).

Each method will be described below.

### 1) Method of Melt-Kneading Polycarbonate Resin (a) and Polycarbonate Resin (b)

Pellets or powder particles of the polycarbonate resin (a) and pellets or powder particles of the polycarbonate resin (b) are melt-kneaded using a mixing apparatus such as a kneader, a twin-screw extruder, or a single-screw extruder. The pellets or powder particles of the polycarbonate resin (a) and the pellets or powder particles of the polycarbonate resin (b) may be mixed in a solid state in advance and then kneaded, or one of them may be molten in the mixing apparatus first, and the other polycarbonate resin may be added thereto and kneaded.

The temperature during kneading is not particularly limited, but is preferably 200° C. or higher, more preferably 220° C. or higher, and still more preferably 230° C. or higher. The temperature is preferably 320° C. or lower, and particularly preferably 300° C. or lower. A low temperature during kneading is not preferable, because the mixing of the polycarbonate resin (a) and the polycarbonate resin (b) is not complete, and there is a concern that the hardness and the impact resistance may vary when a molded article is produced. Too high a temperature during kneading is not preferable, because the color tone of the polycarbonate resin composition may deteriorate.

### 2) Method of Melt-Kneading Polycarbonate Resin (a) in Molten State and Polycarbonate Resin (b) in Molten State

The polycarbonate resin (a) in a molten state and the polycarbonate resin (b) in a molten state are mixed using a mixing apparatus such as a stirring tank, a static mixer, a kneader, a twin-screw extruder, or a single-screw extruder. At this time, for example, in the case of a polycarbonate resin produced by the melt polymerization method, the polycarbonate resin may be introduced into the mixing apparatus in a molten state without cooling or solidifying.

### 3) Method of Mixing Polycarbonate Resin (a) and Polycarbonate Resin (b) in Solution State

In this method, the polycarbonate resin (a) and the polycarbonate resin (b) are dissolved in an appropriate solvent to form a solution, and mixed in the solution state, and then the mixture is isolated as a polycarbonate resin composition.

The pellets or powder particles of the polycarbonate resin (a) and the pellets or powder particles of the polycarbonate resin (b) may be mixed in a solid state in advance, and then dissolved in an appropriate solvent to form a solution. It is also possible to dissolve one of them in an appropriate solvent to prepare a solution, and then add the other polycarbonate resin to the solution.

Examples of the suitable solvent include aliphatic hydrocarbons such as hexane and n-heptane; chlorinated aliphatic hydrocarbons such as dichloromethane, chloroform, carbon tetrachloride, dichloroethane, trichloroethane, tetrachloroethane, dichloropropane and 1,2-dichloroethylene; aromatic hydrocarbons such as benzene, toluene and xylene; substituted aromatic hydrocarbons such as nitrobenzene and acetophenone; and cyclic ethers such as tetrahydrofuran. Among these, for example, chlorinated hydrocarbons such as dichloromethane or chlorobenzene are suitably used. These solvents can be used alone or as a mixture with other solvents.

Examples of the mixing apparatus include a stirring tank and a static mixer. The mixing temperature is not particularly limited as long as the polycarbonate resin (a) and the polycarbonate resin (b) are dissolved, and the mixing is usually performed at a temperature not higher than the boiling point of the solvent to be used.

### 4) Method of Dry-Blending Polycarbonate Resin (a) and Polycarbonate Resin (b)

In this method, pellets or powder particles of the polycarbonate resin (a) and pellets or powder particles of the polycarbonate resin (b) are dry-blended using a tumbler, a super mixer, a Henschel mixer, a Nauta mixer, or the like.

Among the methods 1) to 4), the methods 1) and 2) in which the polycarbonate resin (a) and the polycarbonate resin (b) are melt-kneaded, and the method 4) in which the polycarbonate resin (a) and the polycarbonate resin (b) are dry-blended are preferable.

In the production of the polycarbonate resin composition, a pigment, a dye, a mold release agent, a heat stabilizer, and the like can be appropriately added in any of the above methods, within a range where the object of the present invention is not imparted.

### Molded Article

The molded article of the present invention contains the polycarbonate resin composition of the present invention, and is produced using the polycarbonate resin composition of the present invention. In order to produce a molded article from the polycarbonate resin composition of the present invention, a normal extrusion molding machine or injection molding machine is used.

The molding temperature in molding the polycarbonate resin composition of the present invention is preferably 160° C. or higher, more preferably 180° C. or higher, and still more preferably 200° C. or higher. The molding temperature is preferably 320° C. or lower, and more preferably 300° C. or lower. If the molding temperature is too low, the melt viscosity increases, the fluidity decreases, and the moldability may decrease. Too high a molding temperature is not preferable, because the polycarbonate resin composition is colored, and the color tone of the resulting molded article may be deteriorated. In addition, a polycarbonate resin composition containing a structural unit derived from an aliphatic dihydroxy compound such as the carbonate structural unit (X) may be decomposed at high temperature.

In the injection molding or extrusion molding, a pigment, a dye, a mold release agent, a heat stabilizer, and the like can be appropriately added to the polycarbonate resin composition of the present invention within a range where the object of the present invention is not imparted.

### Injection Molded Article

The injection molded article of the present invention contains the polycarbonate resin composition of the present invention, and is produced using the polycarbonate resin composition of the present invention. In order to produce an injection molded article from the polycarbonate resin composition of the present invention, a normal injection molding machine is used.

The mold temperature in the case of using an injection molding machine or the like is preferably 120° C. or lower, and more preferably 90° C. or lower. The mold temperature is preferably 20° C. or higher, and more preferably 30° C. or higher. When the mold temperature is too high, it is necessary to increase the cooling time in molding, the production cycle of the molded article becomes longer, and the productivity may decrease. Too low a mold temperature is not preferable, because the melt viscosity of the polycarbonate resin composition becomes too high, there is a possibility that a uniform molded article cannot be produced, and a problem such as unevenness on the surface of the molded article occurs.

### Extrusion Molded Article

The extrusion molded article of the present invention contains the polycarbonate resin composition of the present invention, and is produced using the polycarbonate resin composition of the present invention. In order to produce an extrusion molded article from the polycarbonate resin composition of the present invention, a normal extrusion molding machine is used. The extrusion molding machine is generally equipped with a T-die, a round die, or the like, and can provide extrusion molded articles having various shapes.

Examples of the extrusion molded article include a sheet, a film, a plate, a tube, and a pipe. Among these, a sheet or a film is preferable.

### Application

The molded article of the polycarbonate resin composition of the present invention is excellent in self-healing properties, heat resistance and mechanical strength, and therefore can be used in various fields including the interior of vehicles.

### EXAMPLES

Hereinafter, the present invention will be more specifically described based on Examples. The present invention is not limited to the following Examples.

### Measurement and Evaluation Methods

The physical properties of the polycarbonate resins prepared in the following Examples and Comparative Examples were measured and evaluated by the following methods.

### (1) Glass Transition Temperature (Tg)

Measurement was performed using a differential scanning calorimeter (DSC6220, available from SII). The prepared polycarbonate resin was used as a measurement sample without drying. An aluminum sample pan in which about 10 mg of the measurement sample was sealed was heated from 30° C. to 300° C. at a temperature rising rate of 20° C./min and further cooled to −120° C. at a temperature falling rate of 40° C./min, with a nitrogen gas flow of 50 mL/min. Thereafter, the temperature was raised again to 300° C. at a temperature rising rate of 20° C./min. The differential scanning calorimetry curve resulting from the second temperature rise was analyzed as a measurement curve. The glass transition temperature (Tg) was analyzed in accordance with JIS K7121-1987. The extrapolated glass transition starting temperature, which was a temperature of an intersection of a straight line extending the baseline on the low temperature side toward the high temperature side and a tangent drawn at a point where the gradient of the curve of a stepwise change portion of glass transition was maximized, was determined. The extrapolated glass transition temperature was taken as the glass transition temperature (Tg).

### (2) Viscosity Average Molecular Weight (Mv)

The polycarbonate resin was dissolved in methylene chloride (concentration: 6.0 g/L), the intrinsic viscosity (limiting viscosity) [η] (in dL/g) at 20° C. was determined using an Ubbelohde viscometer (available from Moritomo Rika Kogyo), and the viscosity average molecular weight (Mv) was calculated using the Schnell viscosity equation (the following equation).

$$η = 1.23 \times 1 {0}^{- 4} {Mv}^{0.83}$$

### (3) Tensile Modulus of Elasticity

The prepared polycarbonate resin was dried at 100° C. for 3 hours or more. Using an SUS spacer having a thickness of 0.5 mm, a vertical length of 70 mm, and a horizontal length of 70 mm, 4 g of the dried polycarbonate resin was preheated at a hot press temperature of from 200 to 240° C. for 4 minutes, pre-compressed under the condition of a pressure of 2 MPa for 1 minute, and pressurized under the condition of a pressure of 10 MPa for 1 minute with a hot press machine. Thereafter, the spacer was taken out and cooled at room temperature, thereby producing a pressed piece having a thickness of 0.5 mm. The pressed piece was cut with scissors into a thickness of 0.5 mm, a vertical length of 70 mm, and a horizontal length of 10 mm to prepare a strip-shaped test sample. The prepared test sample was subjected to a tensile test at an initial chuck-to-chuck spacing of 45 mm and an initial tensile speed of 1 mm/min using a bench-top precision universal tester AUTOGRAPH AGS-X (available from Shimadzu Corporation). The tensile modulus of elasticity at a displacement of from 0 to 0.3 mm was measured five times, and the mean value was taken as the result. A higher tensile modulus of elasticity indicates better mechanical strength.

### (4) Self-Healing Properties

The test piece prepared by the hot pressing described above was scratched by applying a load of 750 g with a 4H pencil having a lead length of from 5 to 6 mm using a pencil hardness tester (available from Toyo Seiki-Seisaku-sho, Ltd.). This test piece was placed in a dryer (available from Tokyo Rikakikai Co., Ltd.) and heated at 100° C. for 6 hours. The difference in scratch between the sample left to stand at room temperature and the sample heated was evaluated visually and by the tactile sense of the fingers. The case where the scratch of the heated sample disappeared was evaluated as “∘”, the case where the dent of the scratch was recognized to have decreased by the tactile sense of the fingers was evaluated as “Δ”, and the case where the dent of the scratch was not recognized to have decreased by the tactile sense of the fingers was evaluated as “x”. The sample was determined to have self-healing properties when the evaluation was “∘” or “Δ”.

### (5) Heat Resistance

In the self-healing property test described above, the test piece after heating was evaluated as “∘” when there was no change, “Δ” when the test piece was slightly white and turbid, and “x” when the test piece was white and turbid. The test piece was determined to have heat resistance when the evaluation was “∘” or “Δ”.

### Raw Material

The compounds used in the following Examples and Comparative Examples are indicated by the following abbreviations. The compounds used were those available from the following manufacturers.

### Dihydroxy Compound

PO3G500: polytrimethylene ether glycol, number average molecular weight: 562 (available from ALLESSA GmbH, trade name: VELVETOL (registered trademark))
PO3G1000: polytrimethylene ether glycol, number average molecular weight: 1069 (available from ALLESSA GmbH, trade name: VELVETOL (registered trademark))
PO3G2700: polytrimethylene ether glycol, number average molecular weight: 2743 (available from ALLESSA GmbH, trade name: VELVETOL (registered trademark))
PTMG1000: polytetramethylene ether glycol, number average molecular weight: 991 (available from Mitsubishi Chemical Corporation)
PTMG3000: polytetramethylene ether glycol, number average molecular weight: 2840 (available from Mitsubishi Chemical Corporation)
P-2050: aliphatic polyester polyol represented by Formula (9), number average molecular weight: 1965 (available from Kuraray Co., Ltd., trade name: Kuraray Polyol)
BPA: 2,2-bis(4-hydroxyphenyl) propane (=bisphenol A) (available from Mitsubishi Chemical Corporation)
BPC: 2,2-bis(4-hydroxy-3-methylphenyl) propane (=bisphenol C) (available from Honshu Chemical Industry Co., Ltd.)

### Carbonate Ester

DPC: diphenyl carbonate (available from Mitsubishi Chemical Corporation)

### Polymerization Catalyst

Cesium carbonate (available from Kishida Chemical Co., Ltd.)

### Example 1

A raw material mixture was prepared by adding 15.5 g (about 5.6 mmol) of PO3G2700, 84.5 g (about 0.370 mol) of BPA, 84.6 g (about 0.402 mol) of DPC, and a 0.04 wt. % aqueous solution of cesium carbonate as a catalyst into a glass reactor having a content volume of about 570 mL and equipped with a reactor stirrer, a reactor heater, and a reactor pressure adjusting device, so that the amount of cesium carbonate was 1.00 μmol per mol of the total dihydroxy compound.

Next, the operation of reducing the pressure in the glass reactor to about 100 Pa and subsequently returning to atmospheric air with nitrogen was repeated three times to purge the inside of the reactor with nitrogen. After nitrogen purge, the temperature outside the reactor was set to 220° C., and the temperature inside the reactor was gradually raised to dissolve the mixture. The stirrer was then rotated at 100 rpm. Then, the pressure inside the reactor was reduced from 101.3 kPa (760 Torr) to 13.3 kPa (100 Torr) in terms of absolute pressure over 40 minutes while distilling off phenol produced as a by-product by an oligomerization reaction of the dihydroxy compound and DPC performed in the reactor.

Subsequently, the pressure inside the reactor was maintained at 13.3 kPa, and a transesterification reaction was performed for 65 minutes while further distilling off phenol. Thereafter, the temperature outside the reactor was raised to 260° C. over 15 minutes, and the pressure inside the reactor was reduced from 13.3 kPa (100 Torr) to 399 Pa (3 Torr) in terms of absolute pressure over 40 minutes, thereby removing distilled phenol out of the system. Then, the absolute pressure in the reactor was reduced to about 60 Pa (about 0.4 Torr), and a polycondensation reaction was carried out. The rotation speed of the stirrer was decreased with the lapse of the reaction time, and the polycondensation reaction was terminated when the stirrer of the reactor reached a predetermined stirring power.

Then, the pressure inside the reactor was returned with nitrogen to 101.3 kPa in absolute pressure and then raised to 0.1 MPa in gauge pressure, and the polycarbonate resin was taken out in the form of strands from the bottom of the reactor to collect a strand-shaped polycarbonate resin, which was then pelletized using a rotary cutter.

The content proportions of the carbonate structural unit (X) and the carbonate structural unit (Y) in the resulting copolymerized polycarbonate resin, which were determined by calculation from the charged amount of the raw material dihydroxy compound, are as shown in Table 1.

Each evaluation was performed on the resulting polycarbonate resin by the above-described procedure. The results are shown in Table 1.

### Example 2

The procedure described in Example 1 was performed except that a raw material mixture was prepared by adding 19.7 g (about 7.2 mmol) of PO3G2700, 80.3 g (about 0.352 mol) of BPA, 80.7 g (about 0.377 mol) of DPC, and a 0.04 wt. % aqueous solution of cesium carbonate as a catalyst so that the amount of cesium carbonate was 1.0 μmol per mol of the total dihydroxy compound.

Each evaluation was performed on the resulting polycarbonate resin by the above-described procedure. The results are shown in Table 1.

### Example 3

The procedure described in Example 1 was performed except that a raw material mixture was prepared by adding 32.5 g (about 11.9 mmol) of PO3G2700, 87.5 g (about 0.383 mol) of BPA, 89.0 g (about 0.415 mol) of DPC, and a 0.04 wt. % aqueous solution of cesium carbonate as a catalyst so that the amount of cesium carbonate was 1.0 μmol per mol of the total dihydroxy compound.

Each evaluation was performed on the resulting polycarbonate resin by the above-described procedure. The results are shown in Table 1.

### Example 4

The procedure described in Example 1 was performed except that a raw material mixture was prepared by adding 17.9 g (about 6.5 mmol) of PO3G2700, 82.1 g (about 0.320 mol) of BPC, 70.7 g (about 0.330 mol) of DPC, and a 0.04 wt. % aqueous solution of cesium carbonate as a catalyst so that the amount of cesium carbonate was 1.0 μmol per mol of the total dihydroxy compound.

Each evaluation was performed on the resulting polycarbonate resin by the above-described procedure. The results are shown in Table 1.

### Example 5

The procedure described in Example 1 was performed except that a raw material mixture was prepared by adding 19.4 g (about 18.6 mmol) of PO3G1000, 80.6 g (about 0.353 mol) of BPA, 83.6 g (about 0.390 mol) of DPC, and a 0.04 wt. % aqueous solution of cesium carbonate as a catalyst so that the amount of cesium carbonate was 1.0 μmol per mol of the total dihydroxy compound.

Each evaluation was performed on the resulting polycarbonate resin by the above-described procedure. The results are shown in Table 1.

### Example 6

The procedure described in Example 1 was performed except that a raw material mixture was prepared by adding 17.6 g (about 31.4 mmol) of PO3G500, 82.4 g (about 0.361 mol) of BPA, 88.2 g (about 0.412 mol) of DPC, and a 0.04 wt. % aqueous solution of cesium carbonate as a catalyst so that the amount of cesium carbonate was 1.0 μmol per mol of the total dihydroxy compound.

Each evaluation was performed on the resulting polycarbonate resin by the above-described procedure. The results are shown in Table 1.

### Example 7

The procedure described in Example 1 was performed except that a raw material mixture was prepared by adding 20.3 g (about 7.1 mmol) of PTMG3000, 79.8 g (about 0.350 mol) of BPA, 81.7 g (about 0.381 mol) of DPC, and a 0.04 wt. % aqueous solution of cesium carbonate as a catalyst so that the amount of cesium carbonate was 1.0 μmol per mol of the total dihydroxy compound.

Each evaluation was performed on the resulting polycarbonate resin by the above-described procedure. The results are shown in Table 1.

### Example 8

The procedure described in Example 1 was performed except that a raw material mixture was prepared by adding 29.2 g (about 14.8 mmol) of P-2050, 87.5 g (about 0.383 mol) of BPA, 90.4 g (about 0.422 mol) of DPC, and a 0.04 wt. % aqueous solution of cesium carbonate as a catalyst so that the amount of cesium carbonate was 1.0 μmol per mol of the total dihydroxy compound.

Each evaluation was performed on the resulting polycarbonate resin by the above-described procedure. The results are shown in Table 1.

### Comparative Example 1

The procedure described in Example 1 was performed except that a raw material mixture was prepared by adding 2.35 g (about 0.85 mmol) of PO3G2700, 97.7 g (about 0.428 mol) of BPA, 96.4 g (about 0.450 mol) of DPC, and a 0.04 wt. % aqueous solution of cesium carbonate as a catalyst so that the amount of cesium carbonate was 1.0 μmol per mol of the total dihydroxy compound.

Each evaluation was performed on the resulting polycarbonate resin by the above-described procedure. The results are shown in Table 2.

### Comparative Example 2

The procedure described in Example 1 was performed except that a raw material mixture was prepared by adding 32.7 g (about 33.0 mmol) of PTMG1000, 84.0 g (about 0.368 mol) of BPA, 91.1 g (about 0.425 mol) of DPC, and a 0.04 wt. % aqueous solution of cesium carbonate as a catalyst so that the amount of cesium carbonate was 1.0 μmol per mol of the total dihydroxy compound.

Each evaluation was performed on the resulting polycarbonate resin by the above-described procedure. The results are shown in Table 2.

### Comparative Example 3

The procedure described in Example 1 was performed except that a raw material mixture was prepared by adding 46.5 g (about 16.9 mmol) of PO3G2700, 73.5 g (about 0.322 mol) of BPA, 76.2 g (about 0.356 mol) of DPC, and a 0.04 wt. % aqueous solution of cesium carbonate as a catalyst so that the amount of cesium carbonate was 1.0 μmol per mol of the total dihydroxy compound.

Each evaluation was performed on the resulting polycarbonate resin by the above-described procedure. The results are shown in Table 2.

### Comparative Example 4

The procedure described in Example 1 was performed except that a raw material mixture was prepared by adding 35.4 g (about 62.9 mmol) of PO3G500, 81.4 g (about 0.356 mol) of BPA, 94.3 g (about 0.440 mol) of DPC, and a 0.04 wt. % aqueous solution of cesium carbonate as a catalyst so that the amount of cesium carbonate was 1.0 μmol per mol of the total dihydroxy compound.

Each evaluation was performed on the resulting polycarbonate resin by the above-described procedure. The results are shown in Table 2.

### Comparative Example 5

Each evaluation was performed on a bisphenol A polycarbonate (available from Mitsubishi Engineering-Plastics Corporation, trade name: Novarex (registered trademark) 7022J) by the above-described procedure. The results are shown in Table 2.

### Comparative Example 6

A raw material mixture was prepared by adding 100 g (about 0.390 mol) of BPC, 86.1 g (about 0.402 mol) of DPC, and a 0.04 wt. % aqueous solution of cesium carbonate as a catalyst so that the amount of cesium carbonate was 1.5 μmol per mol of the total dihydroxy compound. The procedure described in Example 1 was performed except that the temperature outside the reactor after the temperature was raised from 220° C. was changed from 260° C. to 250° C., that the temperature was raised to 285° C. over 10 minutes after 40 minutes from the completion of the pressure reduction, and that the reaction was carried out at 285° C. until the completion of the polymerization.

Each evaluation was performed on the resulting polycarbonate resin by the above-described procedure. The results are shown in Table 2.

TABLE 1

| | | Examples | | | | | | | |
|---|---|---|---|---|---|---|---|---|---|
| | | 1 | 2 | 3 | 4 | 5 | 6 | 7 | 8 |
| Content proportion (wt. %) of | PO3G500 | | | | | | 16.7 | | |
| carbonate structural unit (X) | PO3G1000 | | | | | 18.1 | | | |
| | PO3G2700 | 14.3 | 18.2 | 25.2 | 16.7 | | | | |
| | PTMG1000 | | | | | | | | |
| | PTMG3000 | | | | | | | 18.7 | |
| | P-2050 | | | | | | | | 23.3 |
| Content proportion (wt. %) of | BPA | 85.7 | 81.8 | 74.8 | | 81.9 | 83.3 | 81.3 | 76.7 |
| carbonate structural unit (Y) | BPC | | | | 83.3 | | | | |

| | | | | | | | | |
|---|---|---|---|---|---|---|---|---|
| Viscosity average molecular weight (Mv) | 23100 | 23300 | 27100 | 19100 | 21900 | 25400 | 21900 | 21460 |
| Glass transition temperature [° C.] | 74 | 50 | 0 | 52 | 58 | 69 | 86 | 54 |
| Heat resistance | ∘ | ∘ | Δ | ∘ | ∘ | ∘ | ∘ | ∘ |
| Self-healing | Δ | ∘ | Δ | ∘ | ∘ | ∘ | Δ | Δ |
| Tensile modulus of elasticity [MPa] | 2010 | 1640 | 1080 | 1830 | 1800 | 2090 | 1490 | 1620 |

TABLE 2

| | | Comparative Example | | | | | |
|---|---|---|---|---|---|---|---|
| | | 1 | 2 | 3 | 4 | 5 | 6 |
| Content proportion (wt. %) of | PO3G500 | | | | 29.0 | | |
| carbonate structural unit (X) | PO3G1000 | | | | | | |
| | PO3G2700 | 2.2 | | 36.4 | | | |
| | PTMG1000 | | 26.4 | | | | |
| | PTMG3000 | | | | | | |
| | P-2050 | | | | | | |
| Content proportion (wt. %) of | BPA | 97.8 | 73.6 | 63.6 | 71.0 | 100 | |
| carbonate structural unit (Y) | BPC | | | | | | 100 |

| | | | | | | |
|---|---|---|---|---|---|---|
| Viscosity average molecular weight (Mv) | 17900 | 13480 | 28400 | 20300 | 21000 | 27700 |
| Glass transition temperature [° C.] | 128 | 7 | −2 | 25 | 145 | 121 |
| Heat resistance | ∘ | x | x | x | ∘ | ∘ |
| Self-healing | x | Δ | Δ | Δ | x | x |
| Tensile modulus of elasticity [MPa] | 2480 | 680 | 60.4 | 1160 | 1800 | 2050 |

### Example 9

4.2 g of the polycarbonate resin (PC1) produced in Comparative Example 4 and 2.8 g of bisphenol A polycarbonate (available from Mitsubishi Engineering-Plastics Corporation, trade name: Novarex (registered trademark) 7022J) (PC2) were dissolved in 60 mL of methylene chloride, and the solution was dried at room temperature for 12 hours to volatilize methylene chloride. Further, drying was performed at 100° C. for 1 hour by a hot air dryer. The dried polycarbonate resin composition was hot-pressed by the method described above to prepare a test piece having a thickness of 0.5 mm, a vertical length of 70 mm, and a horizontal length of 70 mm.

The content proportions of the carbonate structural unit (X) and the carbonate structural unit (Y) in this polycarbonate resin composition are as shown in Table 3.

Each evaluation was performed on this polycarbonate resin composition by the above-described procedure. The results are shown in Table 3. The viscosity average molecular weight (Mv) and the glass transition temperature were evaluated using a test piece after hot pressing.

TABLE 3

| | | Example |
|---|---|---|
| | | 9 |
| Mixing proportion (wt. %) of polycarbonate resin | PC1 | 60 |
| | PC2 | 40 |
| Content proportion (wt. %) of carbonate structural | PO3G500 | 17.4 |
| unit (X) | | |
| Content proportion (wt. %) of carbonate structural | BPA | 82.6 |
| unit (Y) | | |

| | |
|---|---|
| Viscosity average molecular weight (Mv) | 19400 |
| Glass transition temperature [° C.] | 66 |
| Heat resistance | ∘ |
| Self-healing | Δ |
| Tensile modulus of elasticity [MPa] | 2200 |

### Discussion

The following can be seen from the above results.

As shown in Table 1, Examples 1 to 8 show goods results of all of self-healing properties, heat resistance, and mechanical strength, since the content proportion of the carbonate structural unit (X) is 10 mass % or more and less than 26 mass %, and the content proportion of the carbonate structural unit (Y) is more than 74 mass % and 90 mass % or less.

Comparative Example 1, which contains the carbonate structural unit (X) and the carbonate structural unit (Y) but has an excessively small content proportion of the carbonate structural unit (X), does not have self-healing properties. Comparative Examples 2, 3, and 4, which have too high a content of the carbonate structural unit (X), show poor results of heat resistance.

Comparative Examples 5 and 6 are general BPA polycarbonate resin and BPC polycarbonate resin, respectively, and do not have self-healing properties.

Table 3 shows that the polycarbonate resin composition of the present invention is not limited to a copolymerized polycarbonate resin, and may contain the carbonate structural unit (X) and the carbonate structural unit (Y) as a mixture of two types of polycarbonate resins, as long as the polycarbonate resin composition contains the carbonate structural unit (X) and the carbonate structural unit (Y) in predetermined content proportions.

From the above, it can be seen that the polycarbonate resins of Examples 1 to 9, which are the polycarbonate resin compositions of the present invention, are excellent in self-healing properties, heat resistance, and mechanical strength as compared with the polycarbonate resins of Comparative Examples 1 to 5.

Although the present invention has been described in detail with reference to specific embodiments, it will be apparent to those skilled in the art that various modifications can be made within the scope in which the effects of the invention are exhibited.

The present application is based on Japanese Patent Application No. 2023-054759 filed on Mar. 30, 2023, which is incorporated by citation in its entirety.

1. A polycarbonate resin composition comprising:
a carbonate structural unit (X) derived from an aliphatic dihydroxy compound represented by at least one selected from the group consisting of Formula (1), Formula (2), and Formula (8); and
a carbonate structural unit (Y) derived from an aromatic dihydroxy compound represented by Formula (3),
wherein
a content of the carbonate structural unit (X) is 10 mass % or more and less than 26 mass %, and a content of the carbonate structural unit (Y) is more than 74 mass % and 90 mass % or less, per 100 mass % of all carbonate structural units of the polycarbonate resin composition: 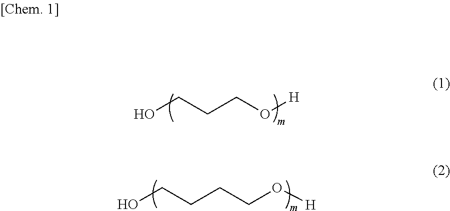
where m is an integer of 2 or more, 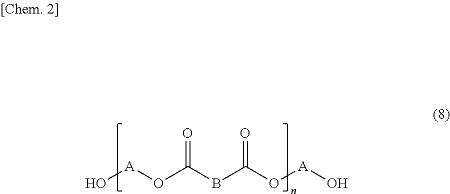
where
A represents a divalent linking group having no cyclic structure, the divalent linking group consisting of from 1 to 15 carbon atoms, from 0 to 1 oxygen atom, and a hydrogen atom, and a plurality of A's in Formula (8) are the same,
B represents a divalent linking group having no cyclic structure, the divalent linking group consisting of from 1 to 40 carbon atoms and a hydrogen atom, and
n is an integer from 2 to 100, 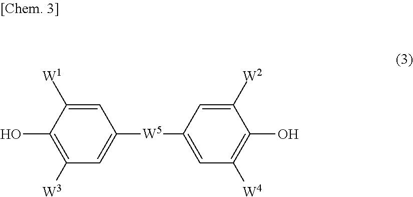
where W¹ to W⁴ are each independently a hydrogen atom, an alkyl group having from 1 to 10 carbon atoms, or an aryl group having from 6 to 12 carbon atoms, and
W⁵ is —CR¹R²— (R¹ and R² are each independently a hydrogen atom, an alkyl group having from 1 to 10 carbon atoms, or an aryl group having from 6 to 12 carbon atoms) or a cycloalkylidene group having from 3 to 10 carbon atoms.

2. The polycarbonate resin composition according to claim 1, wherein the polycarbonate resin composition comprises a copolymerized polycarbonate resin including the carbonate structural unit (X) and the carbonate structural unit (Y).

3. The polycarbonate resin composition according to claim 1, wherein the polycarbonate resin composition is a mixture of a polycarbonate resin including the carbonate structural unit (X) and a polycarbonate resin including the carbonate structural unit (Y).

4. The polycarbonate resin composition according to claim 1, wherein the content of the carbonate structural unit (X) per 100 mass % of all the carbonate structural units of the polycarbonate resin composition is less than 20 mass %.

5. The polycarbonate resin composition according to claim 1, wherein the aromatic dihydroxy compound represented by Formula (3) is an aromatic dihydroxy compound represented by Formula (4) and/or Formula (5).

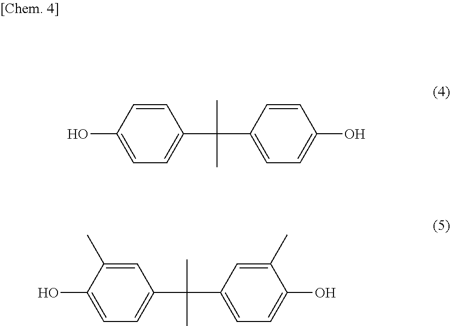 [SMILES: CC(C)(c1ccc(O)cc1)c1ccc(O)cc1 ; Cc1cc(C(C)(C)c2ccc(O)c(C)c2)ccc1O]

6. The polycarbonate resin composition according to claim 1, wherein the aliphatic dihydroxy compound represented by Formula (8) is an aliphatic polyester polyol represented by Formula (9): 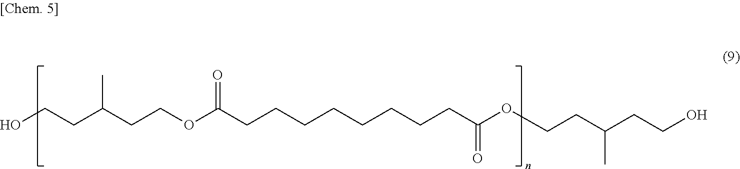
where n is an integer of from 2 to 100.

7. The polycarbonate resin composition according to claim 1, wherein the polycarbonate resin composition has a glass transition temperature of 110° C. or lower.

8. The polycarbonate resin composition according to claim 1, wherein the aliphatic dihydroxy compound represented by at least one selected from the group consisting of Formula (1), Formula (2), and Formula (8) has a number average molecular weight of 20000 or less.

9. The polycarbonate resin composition according to claim 1, wherein the polycarbonate resin composition has a tensile modulus of elasticity of 100 MPa or more and 3000 MPa or less.

10. The polycarbonate resin composition according to claim 1, wherein the polycarbonate resin composition has a viscosity average molecular weight (Mv) in a range from 13000 to 32000.

11. A molded article comprising the polycarbonate resin composition described in claim 1.

12. An injection molded article comprising the polycarbonate resin composition described in claim 1.

13. An extrusion molded article comprising the polycarbonate resin composition described in claim 1.
